(19) United States
(12) Patent Application Publication
(10) Pub. No.: US 2026/0038225 A1
(43) Pub. Date: Feb. 5, 2026

(54) Apparatus for Recognizing Object and Method Thereof

(71) Applicants: Hyundai Motor Company, Seoul (KR); Kia Corporation, Seoul (KR)

(72) Inventor: Jun Hyung Lee, Hwaseong-Si (KR)

(21) Appl. No.: 19/037,926

(22) Filed: Jan. 27, 2025

(30) Foreign Application Priority Data
Aug. 2, 2024 (KR) 10-2024-0103380

(51) Int. Cl. G06V 10/25; G06T 17/00

(52) U.S. Cl. CPC G06V 10/25; G06T 17/00; G06V 2201/07

(57) ABSTRACT

An object recognition apparatus may include a sensor, configured to obtain a point cloud associated with an object, and a processor. The processor may be configured to divide, based on a size of the point cloud, a specified space into a plurality of subspaces. The point cloud may be projected into the specified space. The specified space may include a plurality of voxels included in the plurality of subspaces. The processor may be further configured to identify, among the plurality of voxels and based on sequentially exploring the plurality of voxels, one or more valid voxels that include at least a part of the point cloud; assign, to the one or more valid voxels, at least one index; recognize, based on the one or more valid voxels and the at least one index, the object; and control, based on the recognized object, an operation of a vehicle.

### CROSS-REFERENCE TO RELATED APPLICATION

This application claims the benefit of priority to Korean Patent Application No. 10-2024-0103380, filed in the Korean Intellectual Property Office on Aug. 2, 2024, the entire contents of which are incorporated herein by reference.

### TECHNICAL FIELD

The present disclosure relates to apparatus for recognizing object and method thereof, and more specifically, relates to processing data based on voxels.

### BACKGROUND

Various studies have been conducted to identify external objects using various sensors (e.g., light detection and ranging (LiDAR), radar, cameras, etc.) for assisted or autonomous driving of vehicles.

In particular, various research efforts have been made to voxelize a point cloud is obtained by a sensor and classify valid voxels.

### SUMMARY

The present disclosure has been made to solve the above-mentioned problems occurring in at least some implementations while advantages achieved by those implementations are maintained intact.

An aspect of the present disclosure provides an object recognition apparatus and an object recognition method capable of efficiently identifying valid voxels.

An aspect of the present disclosure provides an object recognition apparatus and an object recognition method capable of dynamically generating a set of valid voxels.

An aspect of the present disclosure provides an object recognition apparatus and an object recognition method capable of obtaining a relationship between valid voxels.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, an object recognition apparatus may include: a sensor configured to obtain a point cloud associated with an object; and a processor. The processor may be configured to divide, based on a size of the point cloud, a specified space into a plurality of subspaces. The point cloud may be projected into the specified space. The specified space may include a plurality of voxels included in the plurality of subspaces. The processor may further be configured to: identify, among the plurality of voxels and based on sequentially exploring the plurality of voxels, one or more valid voxels that include at least a part of the point cloud; assign, to the one or more valid voxels, at least one index associated with at least one of: the plurality of subspaces, the plurality of voxels, or the one or more valid voxels; recognize, based on the one or more valid voxels and the at least one index, the object; and control, based on the recognized object, an operation of a vehicle.

The processor may be configured to assign the at least one index by: assigning, to the one or more valid voxels, at least one of: a first index associated with the plurality of subspaces, a second index associated with the plurality of voxels, a third index associated with axes for acquiring the plurality of voxels, or a fourth index associated with a quantity of sub-voxels, included in the plurality of subspaces, and associated with a quantity of the axes.

The processor may be configured to divide the specified space by: identifying a virtual box that includes the point cloud; identifying, based on a specified direction from which the point cloud is viewed, a diagonal length of the virtual box; and dividing the specified space into the plurality of subspaces based on the diagonal length.

The processor may be configured to identify the one or more valid voxels by: identifying the one or more valid voxels further based on sequentially exploring: a lateral axis extending from a right side of the vehicle to a left side of the vehicle, a longitudinal extending from a rear of the vehicle to a front of the vehicle, and a vertical axis extending from a bottom of the vehicle to a top of the vehicle.

The processor may be further configured to: identify, based on the specified space being divided into a plurality of regions according to the quantity of the axes, the quantity of the sub-voxels; and obtain the fourth index based on the quantity of the axes and the quantity of the sub-voxels.

The processor may be further configured to: obtain the first index based on an order in which the plurality of subspaces are explored.

The processor may be further configured to: identify coordinates of the one or more valid voxels; and obtain the second index based on the coordinates of the one or more valid voxels.

The coordinates of the one or more valid voxels may include coordinate values identified in a vehicle coordinate system of the vehicle. The vehicle coordinate system may include a longitudinal axis extending from a rear of the vehicle to a front of the vehicle, a lateral axis extending from a right side of the vehicle to a left side of the vehicle, and a vertical axis extending from a bottom of the vehicle to a top of the vehicle.

The processor may be further configured to obtain the third index based on the quantity of the axes. The axes may include at least one of: spatial axes or temporal axes.

At least one of a size of each of the plurality of voxels or a size of each of the plurality of subspaces may be set by at least one of a user or a vendor.

The processor may be further configured to: generate a mapping table including at least one of the first index, the second index, the third index, or the fourth index; and output the mapping table.

According to one or more example embodiments of the present disclosure, a method performed by an apparatus of a vehicle may include dividing, based on a size of a point cloud associated with an object, a specified space into a plurality of subspaces. The point cloud may be projected into the specified space. The specified space may include a plurality of voxels included in the plurality of subspaces. The method may further include: identifying, among the plurality of voxels and based on sequentially exploring the plurality of voxels, one or more valid voxels that include at least a part of the point cloud; and assigning, to the one or more valid voxels, at least one index associated with at least one of: the plurality of subspaces, the plurality of voxels, or the one or more valid voxels; recognizing, based on the one or more valid voxels and the at least one index, the object; and controlling, based on the recognized object, an operation of the vehicle.

Assigning the at least one index may include: assigning, to the one or more valid voxels, at least one of: a first index associated with the plurality of subspaces, a second index associated with the plurality of voxels, a third index associated with axes for acquiring the plurality of voxels, or a fourth index associated with a quantity of sub-voxels, included in the plurality of subspaces, and associated with a quantity of axes.

Dividing the specified space may include: identifying a virtual box that includes the point cloud; identifying, based on a specified direction from which the point cloud is viewed, a diagonal length of the virtual box; and dividing the specified space into the plurality of subspaces based on the diagonal length.

Identifying the one or more valid voxels may include: identifying the one or more valid voxels further based on sequentially exploring: a lateral axis extending from a right side of the vehicle to a left side of the vehicle, a longitudinal extending from a rear of the vehicle to a front of the vehicle, and a vertical axis extending from a bottom of the vehicle to extending from a bottom of the vehicle to a top of the vehicle.

The method may further include: identifying, based on the specified space being divided into a plurality of regions according to the quantity of the axes, the quantity of the sub-voxels; and obtaining the fourth index based on the quantity of the axes and the quantity of the sub-voxels.

The method may further include: obtaining the first index based on an order in which the plurality of subspaces are explored.

The method may further include: identifying coordinates of the one or more valid voxels; and obtaining the second index based on the coordinates of the one or more valid voxels.

The coordinates of the one or more valid voxels may include coordinate values identified in a vehicle coordinate system of the vehicle. The vehicle coordinate system may include a longitudinal axis extending from a rear of the vehicle to a front of the vehicle, a lateral axis extending from a right side of the vehicle to a left side of the vehicle, and a vertical axis extending from a bottom of the vehicle to a top of the vehicle.

The method may further include: obtaining the third index based on the quantity of the axes. The axes may include at least one of: spatial axes or temporal axes.

### BRIEF DESCRIPTION OF THE DRAWINGS

The above and other objects, features and advantages of the present disclosure will be more apparent from the following detailed description taken in conjunction with the accompanying drawings:

FIG. 1 illustrates an example of a block diagram relating to an object recognition apparatus;

FIG. 2 illustrates an example of dividing a specified space into a plurality of subspaces;

FIG. 3 shows an example of exploring valid voxels;

FIG. 4 shows an example of a mapping table;

FIG. 5 shows an example of a flowchart associated with an object recognition method; and

FIG. 6 illustrates a computing system related to an object recognition apparatus or an object recognition method.

### DETAILED DESCRIPTION

Hereinafter, one or more example embodiments of the present disclosure will be described in detail with reference to the exemplary drawings. In adding the reference numerals to the components of each drawing, it should be noted that the identical or equivalent component is designated by the identical numeral even if they are displayed on other drawings. Further, in describing the example embodiments of the present disclosure, a detailed description of well-known features or functions will be ruled out in order not to unnecessarily obscure the gist of the present disclosure.

In describing the components of the example embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., assigning indexes to valid voxels in a point cloud) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., assigning indexes to valid voxels in a point cloud) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., assigning indexes to valid voxels in a point cloud) described herein.

Minimum risk maneuver (MRM) operation(s) may also be controlled, for example, based on one or more features (e.g., assigning indexes to valid voxels in a point cloud) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., assigning indexes to valid voxels in a point cloud) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may include an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., assigning indexes to valid voxels in a point cloud) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

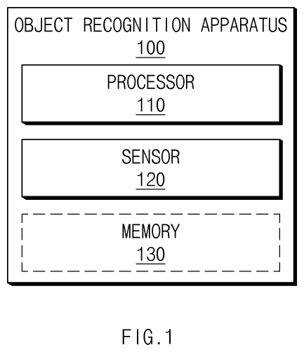

Hereinafter, one or more example embodiments of the present disclosure will be described in detail with reference to FIGS. 1 to 6.

FIG. 1 illustrates an example of a block diagram relating to an object recognition apparatus.

Referring to FIG. 1, an object recognition apparatus 100 may be implemented inside or outside a vehicle, and part of components included in the object recognition apparatus 100 may be implemented inside or outside the vehicle. In this case, the object recognition apparatus 100 may be integrally formed with internal control units of the vehicle, or may be implemented as a separate device and connected to the control units of the vehicle by separate connection means. For example, the object recognition apparatus 100 may further include components not shown in FIG. 1.

The object recognition apparatus 100 may include a processor 110 and a sensor 120. The object recognition apparatus 100 may further include a memory 130. The processor 110, the sensor 120, or the memory 130 may be electronically and/or operably coupled with each other by an electronical component including a communication bus.

Hereinafter, hardware being operatively combined may include a direct connection and/or an indirect connection between the hardware being established in a wired and/or wireless manner, such that second hardware is controlled by first hardware among the hardware.

Although pieces of hardware are illustrated in different blocks, the present disclosure is not limited thereto. A part of the pieces of hardware of FIG. 1 may be included in a single integrated circuit, including a system on a chip (SoC). The types and/or number of pieces of hardware included within the object recognition apparatus 100 are not limited to those shown in FIG. 1. For example, the object recognition apparatus 100 may include only a part of the hardware shown in FIG. 1.

The object recognition apparatus 100 may include hardware for processing data based on one or more instructions. The hardware for processing the data may include a processor 110. For example, the hardware for processing data may include an arithmetic and logic unit (ALU), a floating point unit (FPU), a field programmable gate array (FPGA), a central processing unit (CPU), and/or an application processor (AP). The processor 110 may have the structure of a single-core processor, or the structure of a multi-core processor including dual core, quad core, hexa core, or octa core.

The object recognition apparatus 100 may include the sensor 120 for acquiring a point cloud. For example, the point cloud may include a set of points corresponding to an external object.

For example, the sensor 120 may include at least one of a LiDAR (light detection and ranging), a ToF (time of flight) sensor, a structured light sensor, an ultrasonic sensor, an infrared sensor, an optical distance sensor, or a RADAR (radio detection and ranging), or any combination thereof.

The memory 130 of the object recognition apparatus 100 may include hardware components for storing data and/or instructions that are input to and/or output from the processor 110 of the object recognition apparatus 100. For example, the memory 130 may include a volatile memory including a random-access memory (RAM), or a non-volatile memory including a read-only memory (ROM).

For example, the volatile memory may include at least one of dynamic RAM (DRAM), static RAM (SRAM), cache RAM or pseudo SRAM (PSRAM), or any combination thereof.

For example, the non-volatile memory may include at least one of programmable ROM (PROM), erasable PROM (EPROM), electrically erasable PROM (EEPROM), flash memory, hard disk, compact disc, solid state drive (SSD) or embedded multi-media card (eMMC), or any combination thereof.

The memory 130 may include a neural network model. For example, the neural network model may project the point cloud into a specified space based on inputting of the point cloud acquired via the sensor 120. For example, the neural network model may output information related to sub-voxels including at least a part of the point cloud based on inputting of the point cloud.

The processor 110 of the object recognition apparatus 100 may acquire a point cloud through the sensor 120. For example, the processor 110 may project the point cloud into a specified space including a plurality of voxels. For example, the specified space may be referred to as a full voxel space.

For example, the processor 110 may divide the specified space into a plurality of subspaces by using the size of the point cloud based on projecting the point cloud into the specified space including a plurality of voxels. For example, each of the plurality of subspaces may be referred to as an exploration space.

For example, the processor 110 may identify a virtual box including the point cloud. For example, the virtual box including the point cloud may include a virtual box corresponding to an external object. For example, the virtual box may be expressed in a three-dimensional virtual coordinate system.

For example, the processor 110 may identify a diagonal length of the virtual box based on identifying the virtual box including the point cloud. For example, the processor 110 may identify the diagonal length in case of viewing the virtual box in a specified direction based on identifying the virtual box including the point cloud. The diagonal length of the point cloud may be identified based on the specified direction from which the point cloud is viewed. The specified direction may determine the orientation of the virtual box. For example, the specified direction may include a z-axis direction in the three-dimensional virtual coordinate system. For example, viewing the virtual box in the specified direction may include viewing the virtual box from a bird's-eye view.

For example, the processor 110 may divide the specified space into a plurality of subspaces using the diagonal length based on identifying the diagonal length in case of viewing the virtual box in the specified direction.

The processor 110 may sequentially explore a plurality of voxels included in the plurality of subspaces according to a specified condition. For example, the processor 110 may sequentially explore a plurality of voxels according to a specified condition related to a plurality of axes forming a plurality of subspaces.

For example, the processor 110 may sequentially explore a plurality of voxels based on a y-axis (e.g., a lateral axis) extending from the right side of the vehicle to the left side of the vehicle, an x-axis (e.g., a longitudinal axis) extending from the rear of the vehicle to the front of the vehicle, and a z-axis (e.g., a vertical axis) extending from the bottom of the vehicle to the top of the vehicle.

For example, the processor 110 may identify valid voxels that include at least a part of the point cloud among the plurality of voxels based on sequentially exploring the plurality of voxels, which are included in the plurality of subspaces, according to a specified condition.

For example, the valid voxels may include a voxel in which at least one point exists within the voxel.

For example, the processor 110 may sequentially explore a y-axis that increases toward the left of the vehicle, an x-axis that increases toward the front of the vehicle, and a z-axis that increases toward the top of the vehicle. For example, the processor 110 may identify at least a part of the point cloud in at least some of the plurality of voxels based on sequentially exploring the y-axis increasing toward the left of the vehicle, the x-axis increasing toward the front of the vehicle, and the z-axis increasing toward the top of the vehicle. In other words, the y-axis may extend from a right side of the vehicle to the left side of the vehicle. The x-axis may extend from a rear of the vehicle to a front of the vehicle. The z-axis may extend from a bottom of the vehicle to a top of the vehicle.

For example, the processor 110 may identify valid voxels that include at least a part of the point cloud among the plurality of voxels based on sequentially exploring the y-axis increasing toward the left of the vehicle, the x-axis increasing toward the front of the vehicle, and the z-axis increasing toward the top of the vehicle.

For example, the processor 110 may assign indices to the valid voxels. For example, the processor 110 may assign, to the valid voxels, at least one index associated with at least one of the plurality of subspaces, the plurality of voxels, or the valid voxels, or any combination thereof.

For example, the processor 110 may assign, to the valid voxels, a first index associated with the plurality of subspaces. For example, the processor 110 may assign, to the valid voxels, a second index associated with the plurality of voxels. For example, the processor 110 may assign, to the valid voxels, a third index associated with axes for acquiring the plurality of voxels. For example, the processor 110 may assign, to the valid voxels, a fourth index associated with the number of sub-voxels included in the plurality of subspaces and the number of axes for acquiring the plurality of voxels.

For example, the processor 110 may assign, to the valid voxels, at least one of a first index associated with the plurality of subspaces, a second index associated with the plurality of voxels, the third index associated with axes for acquiring the plurality of voxels, or a fourth index associated with the number of sub-voxels included in the plurality of subspaces and the number of axes, or any combination thereof.

The processor 110 may output information of valid voxels including at least one index based on assigning, to the valid voxels, at least one index associated with at least one of the plurality of subspaces, the plurality of voxels, or the valid voxels, or any combination thereof.

For example, the processor 110 may output the information of the valid voxels, based on generating the information of the valid voxels including at least one index. For example, the information of the valid voxels may include a mapping table including at least one index assigned to the valid voxels.

The processor 110 may acquire a first index based on the order in which the plurality of subspaces are explored.

The processor 110 may identify the coordinates of a voxel in which at least a part of the point cloud is identified. For example, the processor 110 may identify the coordinates of a valid voxel. For example, the processor 110 may acquire a second index based on the coordinates of the voxel. For example, the processor 110 may acquire a second index corresponding to the coordinates of the voxel.

For example, the coordinates of the voxel may include coordinate values identified in a vehicle coordinate system formed around the vehicle. For example, the vehicle coordinate system may include an x-axis that increases toward the front of the vehicle, a y-axis that increases toward the left of the vehicle, and a z-axis that increases toward the top of the vehicle.

The processor 110 may acquire a third index based on the number of axes. For example, the axes may include at least one of spatial axes associated with space, or time axes associated with time (e.g., temporal axes), or any combination thereof.

For example, the spatial axes associated with space may include at least one of the x-axis, the y-axis, or the z-axis, or any combination thereof. For example, the axes associated with time may include a time axis associated with a time point at which the point cloud is acquired.

The processor 110 may identify a specified number of axes and the number of sub-voxels based on dividing a specified space into the specified number of axes. For example, the specified number of axes may include at least one of the x-axis, the y-axis, the z-axis, or the time axis, or any combination thereof.

For example, the processor 110 may acquire a fourth index based on the specified number and the number of sub-voxels.

The processor 110 may generate a mapping table including at least one of a first index, a second index, a third index, or a fourth index, or any combination thereof. For example, the processor 110 may output the generated mapping table.

For example, the processor 110 may output information of valid voxels including the mapping table.

As described above, the object recognition apparatus 100 may assign, to valid voxels, at least one index for classifying valid voxels. The object recognition apparatus 100 may efficiently classify the valid voxels by assigning at least one index to the valid voxels according to a specified condition.

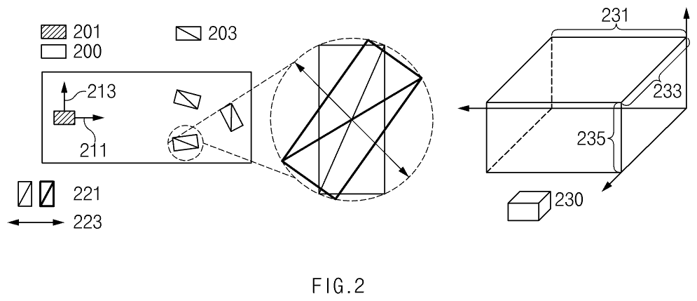

FIG. 2 illustrates an example of dividing a specified space into a plurality of subspaces.

Referring to FIG. 2, a processor (e.g., the processor 110 in FIG. 1) of an object recognition apparatus (e.g., the object recognition apparatus 100 in FIG. 1) may identify virtual boxes 203 corresponding to external objects in a specified space 200. For example, the virtual boxes 203 may include a point cloud acquired through a sensor (e.g., the sensor 120 of FIG. 1).

The processor may identify virtual boxes 203 located in front of a vehicle 201 in the specified space 200. For example, the front of the vehicle 201 may include the direction of a first axis 211 among the first axis 211 and a second axis 213 with respect to the vehicle.

The processor may select a first virtual box 221 among the virtual boxes 203 based on identifying the virtual boxes 203. For example, the processor may identify a diagonal length 223 of the first virtual box 221.

The processor may divide the specified space 200 into a plurality of subspaces based on the identification of the diagonal length 223. For example, a subspace 230 may include one of the plurality of subspaces.

The processor may set the size of the subspace 230 based on the diagonal length 223.

For example, a length 231 of the subspace 230 in the y-axis direction may be equal to the diagonal length 223. For example, a length 233 of the subspace 230 in the x-axis direction may be equal to the diagonal length 223. For example, a length 235 of the subspace 230 in the z-axis direction may be equal to the height of the specified space 200.

For example, the subspace 230 may be referred to as a voxel exploration space. For example, the subspace 230 may include tensor data having a shape of

$$⌈ \frac{r o {i}_{z}}{{v}_{z}} ⌉ \times ⌈ \frac{{diag}_{m e a n}}{{v}_{y}} ⌉ \times ⌈ \frac{{diag}_{m e a n}}{{v}_{x}} ⌉ .$$

For example, the total number of voxels constituting the subspace 230 may be

$$⌈ \frac{r o {i}_{z}}{{v}_{z}} ⌉ \times ⌈ \frac{{diag}_{m e a n}}{{v}_{y}} ⌉ \times ⌈ \frac{{diag}_{m e a n}}{{v}_{x}} ⌉ .$$

The above-described roi_{z} may include the height of the specified space 200. The above-described diagₘₑₐₙ may include the diagonal length 223. The above-described v_{z} may include the height of a voxel. The above-described v_{y} may include the length of a voxel in the y-direction. The above-described vₓ may include the length of the voxel in the x-direction.

The processor may identify at least one valid voxel among voxels included in the subspace 230 based on obtaining the subspace 230.

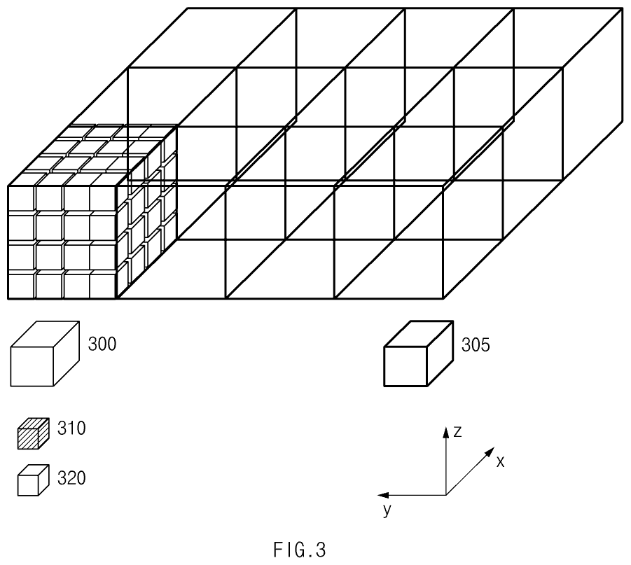

FIG. 3 illustrates an example of exploring a valid voxel.

Referring to FIG. 3, a processor (e.g., the processor 110 of FIG. 1) of an object recognition apparatus (e.g., the object recognition apparatus 100 of FIG. 1) may divide a specified space 300 into a plurality of subspaces 305.

The processor may identify voxels 310 and 320 included in the subspaces 305. For example, the processor may identify, among the voxels 310 and 320, the valid voxels 310 that include at least a part of a point cloud. For example, the processor may identify, among the voxels 310 and 320, the empty voxels 320 that do not include at least a part of the point cloud.

For example, the processor may sequentially explore the voxels 310 and 320. For example, the processor may explore the voxels 310 and 320 in the y-axis direction. For example, the processor may explore the voxels 310 and 320 in the x-axis direction based on exploring the voxels 310 and 320 in the y-axis direction. For example, the processor may explore the voxels 310 and 320 in the z-axis direction based on exploring the voxels 310 and 320 in the x-axis direction.

For example, the processor may move by a shift of 1 in the x-axis direction and explore the voxels 310 and 320 in the y-axis direction again based on exploring the voxels 310 and 320 in the y-axis direction. If the above-described process is repeatedly performed to explore all of the voxels 310 and 320 located on the first floor, the processor may move by the shift of 1 in the z-axis direction to explore the voxels 310 and 320 in the y-axis direction.

As described above, the processor may first explore the voxels 310 and 320 located on each layer in the y-axis direction, and then perform exploration while moving by the shift of 1 in the x-axis direction. By repeatedly performing the above-described processes, the processor may identify the valid voxels 310.

The processor may identify coordinate values of the valid voxels 310. For example, the processor may identify the coordinate values corresponding to the positions of the valid voxels 310. The coordinate values corresponding to the positions of the valid voxels 310 may be referred to as system voxel space coordinates.

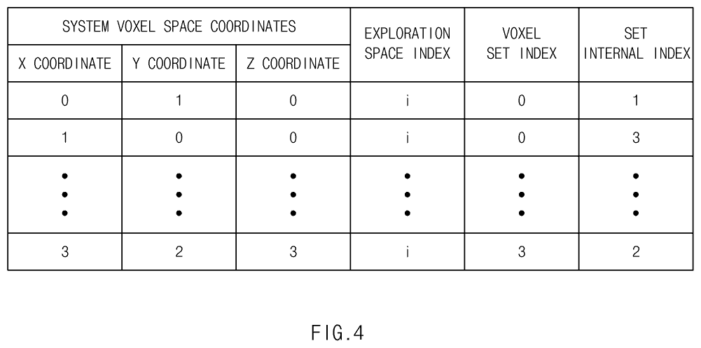

FIG. 4 illustrates an example of a mapping table.

Referring to FIG. 4, a processor (e.g., the processor 110 of FIG. 1) of an object recognition apparatus (e.g., the object recognition apparatus 100 of FIG. 1) may generate a mapping table. For example, the mapping table may include at least one of a system voxel space coordinate, an exploration space index, a voxel set index, or a set internal index, or any combination thereof. For example, the mapping table may include a system voxel space coordinate, an exploration space index, a voxel set index, and a set internal index.

For example, the exploration space index may include a first index. For example, the system voxel space coordinate may include a second index. For example, the set internal index may include a third index. For example, the voxel set index may include a fourth index.

A process of obtaining the system voxel space coordinate, the exploration space index, the voxel set index, and the set internal index is described below.

The processor may identify the coordinates of a valid voxel based on identifying the valid voxel that includes at least a part of a point cloud. For example, the coordinates of the valid voxel may be expressed based on a vehicle coordinate system formed around a vehicle. For example, the coordinates of the valid voxel may include an x-coordinate, a y-coordinate, and a z-coordinate of a voxel that include at least a part of a point cloud in a vehicle coordinate system formed around the vehicle.

For example, the processor may obtain system voxel space coordinates including the coordinates of the valid voxel. Based on obtaining the system voxel space coordinates, the processor may store the system voxel space coordinates in at least a portion of the mapping table.

The processor may obtain an exploration space index. For example, the exploration space index may include indices assigned to subspaces included in a specified space. For example, the processor may assign an index to each subspace to indicate a position of the subspace or an order in which the subspace is identified based on dividing the specified space into subspaces (e.g., regions).

For example, the processor may sequentially explore the subspaces according to the exploration space index. For example, the processor may explore a subspace to which a first exploration space index is assigned, and then explore a subspace to which the second exploration space index is assigned. As described above, the processor may explore the voxels included in the subspaces according to the order of the exploration space indices respectively assigned to the subspaces.

The processor may obtain a voxel set index. For example, the processor may obtain the voxel set index based on the number of voxels included in the exploration space and the size of the voxel set. For example, the voxel set index may be related to the number of dynamic voxel sets.

For example, the number of voxels included in the exploration space may include the number of all voxels included in a subspace. For example, the size of the voxel set may include a value obtained by dividing the number of voxels included in the exploration space by the exploration space partition size. For example, the exploration space partition size may be expressed as 2^{N}. Here, N may include the number of axes forming a voxel space. Therefore, if the voxel space is formed by the x-axis, y-axis, and z-axis, N may be 3. For another example, if the voxel space is formed by the x-axis, y-axis, z-axis, and time axis, N may be 4. For example, if the value obtained by dividing the number of voxels included in the exploration space by the size of the voxel set is not a natural number, the processor may obtain a natural number by rounding up the value to the nearest decimal place and set the obtained natural number as a voxel set index.

The processor may obtain a set internal index. For example, the set internal index may be related to the size of a voxel set. For example, the size of the voxel set may include a value obtained by dividing the number of voxels included in the exploration space by the exploration space partition size, as described above.

As described above, the processor of the object recognition apparatus may generate a mapping table including system voxel space coordinates, an exploration space index, a voxel set index, and a set internal index. The processor may output the generated mapping table, or control the vehicle using the generated mapping table.

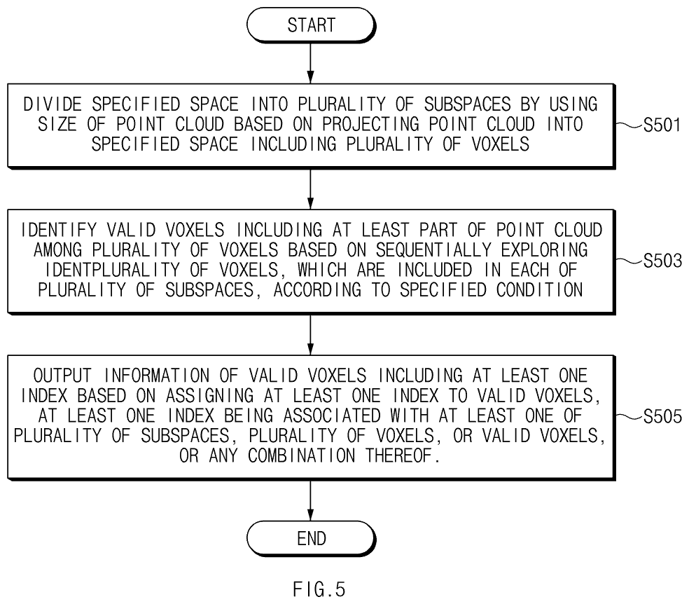

FIG. 5 shows an example of a flowchart associated with an object recognition method.

Hereinafter, it is assumed that the object recognition apparatus 100 of FIG. 1 performs the process of FIG. 5. Additionally, in the description of FIG. 5, operations described as being performed by the apparatus may be understood as being controlled by the processor 110 of the object recognition apparatus 100.

At least one of operations of FIG. 5 may be performed by the object recognition apparatus 100 of FIG. 1. At least one of operations of FIG. 5 may be performed by the processor 110 of FIG. 1. The operations in FIG. 5 may be performed sequentially, but is not necessarily performed sequentially. For example, the order of the operations may be changed, and at least two operations may be performed in parallel.

Referring to FIG. 5, in operation S501, the object recognition method may include dividing a specified space into a plurality of subspaces by using the size of a point cloud based on projecting the point cloud into the specified space including a plurality of voxels.

For example, the object recognition method may include identifying a virtual box including the point cloud. For example, the object recognition method may include identifying a diagonal length if the virtual box is viewed in a specified direction. For example, the object recognition method may include identifying the diagonal length if the virtual box is viewed in the specified direction based on identifying the virtual box including the point cloud. For example, the object recognition method may include dividing the specified space into a plurality of subspaces by using the diagonal length.

For example, the object recognition method may include identifying the diagonal length if the virtual box is viewed in a specified direction based on identifying the virtual box including the point cloud. For example, the object recognition method may include dividing the specified space into a plurality of subspaces by using the diagonal length.

For example, the size of each of the plurality of voxels may be set by at least one of a user or a vendor, or any combination thereof. For example, the size of each of the plurality of subspaces may be set by at least one of the user or the vendor, or any combination thereof. For example, at least one of the size of each of the plurality of voxels or the size of each of the plurality of subspaces, or any combination thereof may be set by at least one of the user, or the vendor, or any combination thereof.

In operation S503, the object recognition method may include identifying valid voxels that include at least a part of the point cloud among the plurality of voxels based on sequentially exploring the plurality of voxels, which are included in each of the plurality of subspaces, according to a specified condition.

For example, the object recognition method may include identifying valid voxels that include at least a part of the point cloud based on sequentially exploring the y-axis increasing toward the left of the vehicle, the x-axis increasing toward the front of the vehicle, and the z-axis increasing toward the top of the vehicle.

In operation S505, the object recognition method may include outputting information of valid voxels including at least one index based on assigning at least one index to valid voxels, the at least one index being associated with at least one of a plurality of subspaces, a plurality of voxels, or valid voxels, or any combination thereof. The vehicle may recognize an object (e.g., determine a position, an orientation, a size, etc. of the object) associated with the point cloud based on the valid voxels including at least one index. An operation (e.g., autonomous driving) of the vehicle may be performed based on the recognized object.

For example, the object recognition method may include assigning, to the valid voxels, at least one of a first index associated with the plurality of subspaces, a second index associated with the plurality of voxels, the third index associated with axes for acquiring the plurality of voxels, or a fourth index associated with the number of sub-voxels included in the plurality of subspaces and the number of axes, or any combination thereof.

For example, the object recognition method may include obtaining a first index based on the order in which the plurality of subspaces are explored.

For example, the object recognition method may include identifying coordinates of a valid voxel that includes at least a part of the point cloud. For example, the object recognition method may include obtaining a second index based on the coordinates of the valid voxel.

For example, the coordinates of the valid voxel may include coordinate values identified in a vehicle coordinate system formed around a vehicle.

For example, the vehicle coordinate system may include an x-axis that increases toward the front of the vehicle, a y-axis that increases toward the left of the vehicle, and a z-axis that increases toward the top of the vehicle.

For example, the object recognition method may include obtaining a third index based on the number of axes. For example, the axes may include at least one of spatial axes associated with space, or time axes associated with time, or any combination thereof.

For example, the object recognition method may include identifying a specified number of axes and the number of sub-voxels based on dividing a specified space into one or more regions according to the specified number of axes. For example, the object recognition method may include obtaining a fourth index based on the specified number and the number of sub-voxels.

The object recognition method may include generating a mapping table including at least one of a first index, a second index, a third index, or a fourth index, or any combination thereof. For example, the object recognition method may include generating a mapping table including the first index, the second index, the third index, and the fourth index. For example, an object recognition method may include outputting the generated mapping table.

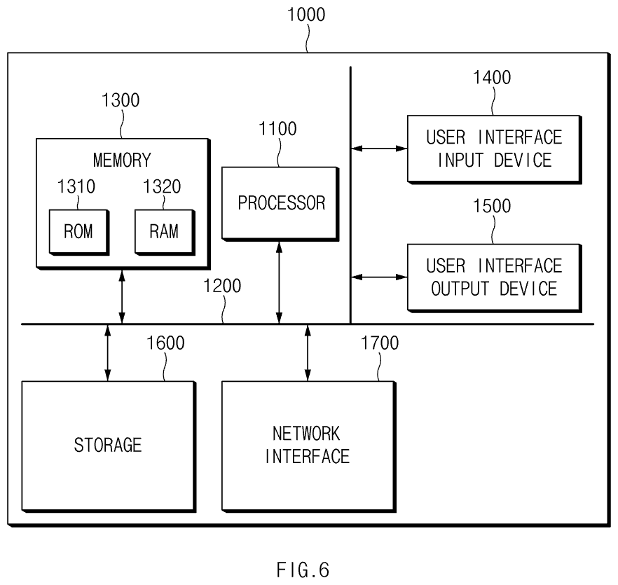

FIG. 6 illustrates a computing system related to an object recognition apparatus or an object classification method.

Referring to FIG. 6, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read Only Memory (ROM) and a Random Access Memory (RAM).

Thus, the operations of the method or the algorithm described herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

According to an aspect of the present disclosure, an object recognition apparatus includes a sensor that obtains a point cloud and a processor. The processor may divide a specified space into a plurality of subspaces by using a size of the point cloud based on projecting the point cloud into the specified space including a plurality of voxels, identify valid voxels including at least a part of the point cloud among the plurality of voxels based on sequentially exploring the plurality of voxels included in the plurality of subspaces according to a specified condition, and output information of the valid voxels including at least one index based on assigning, to the valid voxels, the at least one index associated with at least one of the plurality of subspaces, the plurality of voxels, or the valid voxels, or any combination thereof.

The processor may assign, to the valid voxels, at least one of a first index associated with the plurality of subspaces, a second index associated with the plurality of voxels, the third index associated with axes for acquiring the plurality of voxels, or a fourth index associated with a number of sub-voxels included in the plurality of subspaces and the number of axes, or any combination thereof.

The processor may identify a diagonal length if a virtual box including the point cloud is viewed in a specified direction based on identifying the virtual box, and divide the specified space into the plurality of subspaces by using the diagonal length.

The processor may identify valid voxels including at least a part of the point cloud based on sequentially exploring a y-axis increasing toward a left of a vehicle, an x-axis increasing toward a front of the vehicle, and a z-axis increasing toward a top of the vehicle.

The processor may identify a specified number of axes and the number of the voxels, based on dividing the specified space into the specified number of axes, and obtain the fourth index based on the specified number and the number of the sub-voxels.

The processor may obtain the first index based on an order in which the plurality of subspaces are explored.

The processor may identify coordinates of the valid voxels including at least a part of the point cloud, and obtain the second index based on the coordinates of the valid voxels.

The coordinates of the valid voxels may include coordinate values identified in a vehicle coordinate system with respect to a vehicle. The vehicle coordinate system may include an x-axis increasing toward a front of the vehicle, a y-axis increasing toward a left of the vehicle, and a z-axis increasing toward a top of the vehicle.

The processor may obtain the third index based on the number of the axes. The axes may include at least one of spatial axes associated with space, or time axes associated with time, or any combination thereof.

At least one of a size of each of the plurality of voxels, or a size of each of the plurality of subspaces, or any combination thereof may be set by at least one of a user, or a vendor, or any combination thereof.

The processor may generate a mapping table including at least one of the first index, the second index, the third index, or the fourth index, or any combination thereof, and output the mapping table.

According to an aspect of the present disclosure, an object recognition method includes dividing, by a processor, a specified space into a plurality of subspaces by using a size of a point cloud based on projecting the point cloud into the specified space including a plurality of voxels, identifying valid voxels including at least a part of the point cloud based on sequentially exploring the plurality of voxels included in the plurality of subspaces according to a specified condition, and outputting information of the valid voxels including at least one index based on assigning, to the valid voxels, the at least one index associated with at least one of the plurality of subspaces, the plurality of voxels, or the valid voxels, or any combination thereof.

The object recognition method may further include assigning, to the valid voxels, at least one of a first index associated with the plurality of subspaces, a second index associated with the plurality of voxels, the third index associated with axes for acquiring the plurality of voxels, or a fourth index associated with the number of sub-voxels included in the plurality of subspaces and the number of axes, or any combination thereof.

The object recognition method may further include identifying a diagonal length if a virtual box including the point cloud is viewed in a specified direction based on identifying the virtual box, and dividing the specified space into the plurality of subspaces by using the diagonal length.

The object recognition method may further include identifying valid voxels including at least a part of the point cloud based on sequentially exploring a y-axis increasing toward a left of a vehicle, an x-axis increasing toward a front of the vehicle, and a z-axis increasing toward a top of the vehicle.

The object recognition method may further include identifying a specified number of axes and the number of the voxels, based on dividing the specified space into the specified number of axes, and obtaining the fourth index based on the specified number and the number of the sub-voxels.

The object recognition method may further include obtaining the first index based on an order in which the plurality of subspaces are explored.

The object recognition method may further include identifying coordinates of the valid voxels including at least a part of the point cloud, and obtaining the second index based on the coordinates of the valid voxels.

The coordinates of the valid voxels may include coordinate values identified in a vehicle coordinate system with respect to a vehicle. The vehicle coordinate system may include an x-axis increasing toward a front of the vehicle, a y-axis increasing toward a left of the vehicle, and a z-axis increasing toward a top of the vehicle.

The object recognition method may further include obtaining the third index based on the number of the axes. The axes may include at least one of spatial axes associated with space, or time axes associated with time, or any combination thereof.

The above description is merely illustrative of the technical idea of the present disclosure, and various modifications and variations may be made without departing from the essential characteristics of the present disclosure by those skilled in the art to which the present disclosure pertains.

Accordingly, the one or more example embodiments disclosed in the present disclosure are not intended to limit the technical idea of the present disclosure but to describe the present disclosure, and the scope of the technical idea of the present disclosure is not limited by the example embodiments. The scope of protection of the present disclosure should be interpreted by the following claims, and all technical ideas within the scope equivalent thereto should be construed as being included in the scope of the present disclosure.

The present technique may efficiently identify valid voxels.

Further, the present technique may dynamically generate a set of valid voxels.

Further, the present technique may obtain a relationship between valid voxels.

Besides, a variety of effects directly or indirectly understood through the present disclosure may be provided.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An object recognition apparatus comprising:
a sensor configured to obtain a point cloud associated with an object; and
a processor,
wherein the processor is configured to:
divide, based on a size of the point cloud, a specified space into a plurality of subspaces, wherein the point cloud is projected into the specified space, and wherein the specified space comprises a plurality of voxels included in the plurality of subspaces;
identify, among the plurality of voxels and based on sequentially exploring the plurality of voxels, one or more valid voxels that comprise at least a part of the point cloud;
assign, to the one or more valid voxels, at least one index associated with at least one of: the plurality of subspaces, the plurality of voxels, or the one or more valid voxels;
recognize, based on the one or more valid voxels and the at least one index, the object; and
control, based on the recognized object, an operation of a vehicle.

2. The object recognition apparatus of claim 1, wherein the processor is configured to assign the at least one index by:
assigning, to the one or more valid voxels, at least one of:
a first index associated with the plurality of subspaces,
a second index associated with the plurality of voxels,
a third index associated with axes for acquiring the plurality of voxels, or
a fourth index associated with a quantity of sub-voxels, included in the plurality of subspaces, and associated with a quantity of the axes.

3. The object recognition apparatus of claim 1, wherein the processor is configured to divide the specified space by:
identifying a virtual box that comprises the point cloud;
identifying, based on a specified direction from which the point cloud is viewed, a diagonal length of the virtual box; and
dividing the specified space into the plurality of subspaces based on the diagonal length.

4. The object recognition apparatus of claim 1, wherein the processor is configured to identify the one or more valid voxels by:
identifying the one or more valid voxels further based on sequentially exploring: a lateral axis extending from a right side of the vehicle to a left side of the vehicle, a longitudinal extending from a rear of the vehicle to a front of the vehicle, and a vertical axis extending from a bottom of the vehicle to a top of the vehicle.

5. The object recognition apparatus of claim 2, wherein the processor is further configured to:
identify, based on the specified space being divided into a plurality of regions according to the quantity of the axes, the quantity of the sub-voxels; and
obtain the fourth index based on the quantity of the axes and the quantity of the sub-voxels.

6. The object recognition apparatus of claim 2, wherein the processor is further configured to:
obtain the first index based on an order in which the plurality of subspaces are explored.

7. The object recognition apparatus of claim 2, wherein the processor is further configured to:
identify coordinates of the one or more valid voxels; and
obtain the second index based on the coordinates of the one or more valid voxels.

8. The object recognition apparatus of claim 7, wherein the coordinates of the one or more valid voxels comprise coordinate values identified in a vehicle coordinate system of the vehicle, and
wherein the vehicle coordinate system comprises a longitudinal axis extending from a rear of the vehicle to a front of the vehicle, a lateral axis extending from a right side of the vehicle to a left side of the vehicle, and a vertical axis extending from a bottom of the vehicle to a top of the vehicle.

9. The object recognition apparatus of claim 2, wherein the processor is further configured to obtain the third index based on the quantity of the axes, and
wherein the axes comprise at least one of: spatial axes or temporal axes.

10. The object recognition apparatus of claim 1, wherein at least one of a size of each of the plurality of voxels or a size of each of the plurality of subspaces is set by at least one of a user or a vendor.

11. The object recognition apparatus of claim 2, wherein the processor is further configured to:
generate a mapping table comprising at least one of the first index, the second index, the third index, or the fourth index; and
output the mapping table.

12. A method performed by an apparatus of a vehicle, the method comprising:
dividing, based on a size of a point cloud associated with an object, a specified space into a plurality of subspaces, wherein the point cloud is projected into the specified space, and wherein the specified space comprises a plurality of voxels included in the plurality of subspaces;
identifying, among the plurality of voxels and based on sequentially exploring the plurality of voxels, one or more valid voxels that comprise at least a part of the point cloud; and
assigning, to the one or more valid voxels, at least one index associated with at least one of: the plurality of subspaces, the plurality of voxels, or the one or more valid voxels;
recognizing, based on the one or more valid voxels and the at least one index, the object; and
controlling, based on the recognized object, an operation of the vehicle.

13. The method of claim 12, wherein the assigning of the at least one index comprises:
assigning, to the one or more valid voxels, at least one of:
a first index associated with the plurality of subspaces,
a second index associated with the plurality of voxels,
a third index associated with axes for acquiring the plurality of voxels, or
a fourth index associated with a quantity of sub-voxels, included in the plurality of subspaces, and associated with a quantity of axes.

14. The method of claim 12, wherein the dividing of the specified space comprises:
identifying a virtual box that comprises the point cloud;
identifying, based on a specified direction from which the point cloud is viewed, a diagonal length of the virtual box; and
dividing the specified space into the plurality of subspaces based on the diagonal length.

15. The method of claim 12, wherein the identifying of the one or more valid voxels comprises:
identifying the one or more valid voxels further based on sequentially exploring: a lateral axis extending from a right side of the vehicle to a left side of the vehicle, a longitudinal extending from a rear of the vehicle to a front of the vehicle, and a vertical axis extending from a bottom of the vehicle to extending from a bottom of the vehicle to a top of the vehicle.

16. The method of claim 13, further comprising:
identifying, based on the specified space being divided into a plurality of regions according to the quantity of the axes, the quantity of the sub-voxels; and
obtaining the fourth index based on the quantity of the axes and the quantity of the sub-voxels.

17. The method of claim 13, further comprising:
obtaining the first index based on an order in which the plurality of subspaces are explored.

18. The method of claim 13, further comprising:
identifying coordinates of the one or more valid voxels; and
obtaining the second index based on the coordinates of the one or more valid voxels.

19. The method of claim 18, wherein the coordinates of the one or more valid voxels comprise coordinate values identified in a vehicle coordinate system of the vehicle, and
wherein the vehicle coordinate system comprises a longitudinal axis extending from a rear of the vehicle to a front of the vehicle, a lateral axis extending from a right side of the vehicle to a left side of the vehicle, and a vertical axis extending from a bottom of the vehicle to a top of the vehicle.

20. The method of claim 13, further comprising:
obtaining the third index based on the quantity of the axes, and
wherein the axes comprise at least one of: spatial axes or temporal axes.
